(19) United States
(12) Patent Application Publication
(10) Pub. No.: US 2020/0353646 A1
(43) Pub. Date: Nov. 12, 2020

(54) COMBINATION OF WOOD AND PLASTIC TABLEWARE

(71) Applicant: Ervin Issagholian, Vernon, CA (US)

(72) Inventor: Ervin Issagholian, Vernon, CA (US)

(21) Appl. No.: 16/405,103

(22) Filed: May 7, 2019

(51) Int. Cl. B29B 9/12; A47G 21/02; B29C 48/00; A47G 21/04; A47G 19/02; A47G 19/22; B29C 48/40; B29C 45/20

(52) U.S. Cl. CPC B29B 9/12; A47G 21/02; B29C 48/022; A47G 21/04; B29C 2948/92885; A47G 19/22; B29C 48/40; B29C 45/20; A47G 2400/10; A47G 19/02

(57) ABSTRACT

A system and method of creating tableware includes blending wood particles with plastic to create a wood and plastic blend. The wood and plastic blend is then pressure injected into a mold to create a wood and plastic blend tableware. The wood and plastic blend tableware is then removed from the mold.

### BACKGROUND OF THE INVENTION

The present invention relates to tableware and, more particularly, to a combination of wood and plastic tableware.

Disposable tableware may be made of paper, wood, or plastic. Disposable cups and cutlery are most commonly made of plastic. These products are prevalent in fast food restaurants, takeaways, but also for airline meals. In private settings, this kind of disposable products has proven very popular with consumers who prefer easy and quick cleanup after parties, etc. Large amounts of non-biodegradable plastic cups and cutlery are typically thrown away after consumption.

As can be seen, there is a need for tableware that includes a reduced amount of plastic.

### SUMMARY OF THE INVENTION

In one aspect of the present invention, a method of creating tableware comprises: blending wood particles with plastic to create a wood and plastic blend; pressure injecting the wood and plastic blend into a mold to create a wood and plastic blend tableware; and removing the wood and plastic blend tableware from the mold.

In another aspect of the present invention, a method of creating tableware comprises: blending wood particles with plastic in a twin-screw extruder to create a plurality of wood and plastic pellets; pressure injecting the wood and plastic pellets into a mold to create a wood and plastic blend tableware; and removing the wood and plastic blend tableware from the mold.

These and other features, aspects and advantages of the present invention will become better understood with reference to the following drawings, description and claims.

### BRIEF DESCRIPTION OF THE DRAWINGS

FIG. 1 is a flow chart of an embodiment of the present invention; and

FIG. 2 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a system and method to produce tableware with a combination of wood and plastic. The present invention decreases the use of nonbiodegradable plastic and increases the use of biodegradable wood, helping the environment. The wood and plastic are combined in different ratios using a twin-screw extrusion blending system and then pelletized. The pellets are then conveyed to a high-pressure injection molding machine which injects them into molds to produce utensils, cups, plates, and containers referred to as disposable tableware.

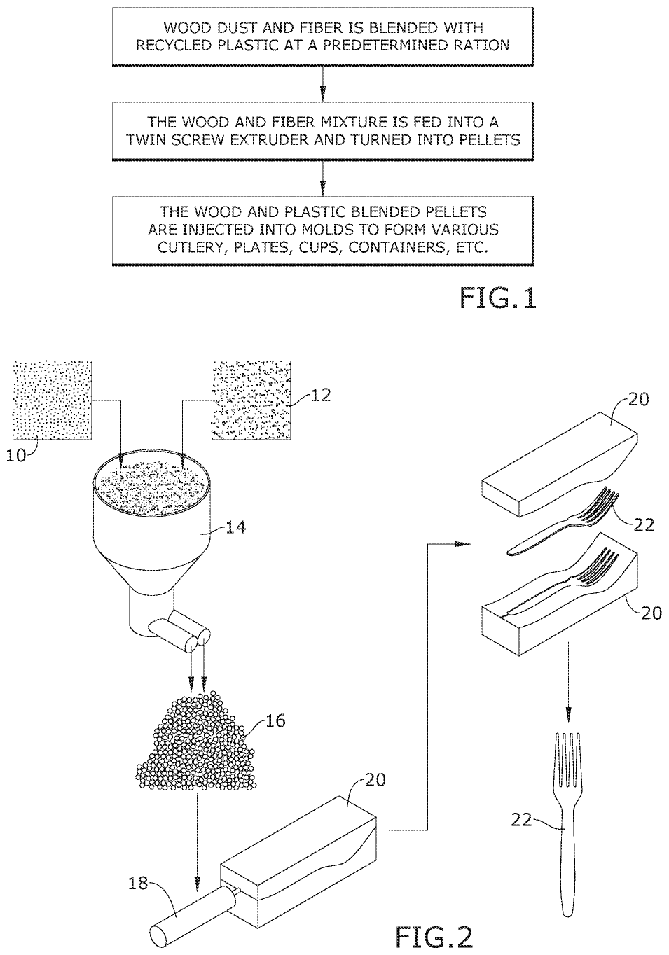

Referring to FIGS. 1 and 2, the present invention includes a system and method of creating tableware. The system and method includes blending wood particles 10 with plastic 12 to create a wood and plastic blend. The wood and plastic blend is then pressure injected into a mold 20 to create a wood and plastic blend tableware 22. The wood and plastic blend tableware 22 is then removed from the mold 20.

The wood particles 10 can be sawdust, wood fibers, or other types of ground and small particles of wood. The plastic 12 may be any type of recyclable plastic. In certain embodiments, the wood particles 10 and plastic 12 are bended using a twin-screw extruder 14 to generate a plurality of wood and plastic blend pellets 16. In such embodiments, the wood plastic blend pellets 16 may be injected by an injection gun 18 into the mold 20.

The wood and plastic blend may include a variety of proportions of wood particles 10 and plastic 12. For example, the wood and plastic blend may be approximately 50% wood and approximately 50% plastic.

The wood and plastic blend tableware 22 may be any type of tableware 22, such as a fork, a spoon, a plate, a cup, and a container. As illustrated in the Figures, the wood and plastic blend tableware 22 may be a fork.

It should be understood, of course, that the foregoing relates to exemplary embodiments of the invention and that modifications may be made without departing from the spirit and scope of the invention as set forth in the following claims.

What is claimed is:

1. A method of creating tableware comprising:
blending wood particles with plastic to create a wood and plastic blend;
pressure injecting the wood and plastic blend into a mold to create a wood and plastic blend tableware; and
removing the wood and plastic blend tableware from the mold.

2. The method of claim 1, wherein the step of blending the wood particles with plastic comprises blending the wood particles in a twin-screw extruder.

3. The method of claim 2, wherein the wood and plastic blend is in the form of pellets.

4. The method of claim 1, wherein the step of pressure injecting the wood and plastic blend into the mold is performed using an injection gun.

5. The method of claim 1, wherein the wood and plastic blend tableware comprises at least one of a fork, a spoon, a plate, a cup, and a container.

6. The method of claim 1, wherein the wood and plastic blend is approximately 50% wood and approximately 50% plastic.

7. A method of creating tableware comprising:
blending wood particles with plastic in a twin-screw extruder to create a plurality of wood and plastic pellets;
pressure injecting the wood and plastic pellets into a mold to create a wood and plastic blend tableware; and
removing the wood and plastic blend tableware from the mold.

8. The method of claim 7, wherein the step of pressure injecting the wood and plastic pellets into the mold is performed using an injection gun.

9. The method of claim 7, wherein the wood and plastic blend tableware comprises at least one of a fork, a spoon, a plate, a cup, and a container.

10. The method of claim 7, wherein the wood and plastic pellet is approximately 50% wood and approximately 50% plastic.
